(19) United States
(12) Patent Application Publication
(10) Pub. No.: US 2025/0108779 A1
(43) Pub. Date: Apr. 3, 2025

(54) TIRE FILLING SYSTEMS, DEVICES AND METHODS

(71) Applicant: Cypress Semiconductor Corporation, San Jose, CA (US)

(72) Inventors: Bradley EVANS, Northville, MI (US); Nicholas Stopher, White Lake, MI (US); Thomas Lemense, Farmington, MI (US); Alan Merlock, Prairie Grove, IL (US)

(73) Assignee: Cypress Semiconductor Corporation, San Jose, CA (US)

(21) Appl. No.: 18/477,413

(22) Filed: Sep. 28, 2023

(51) Int. Cl. B60S 5/04; B60C 23/04; B60C 25/00; G07C 5/08

(52) U.S. Cl. CPC B60S 5/046; B60C 23/0408; B60C 23/0479; B60C 25/002; G07C 5/0841

(57) ABSTRACT

A method can include, by operation of a vehicle system, receiving tire profile data for each of a plurality of tires of the vehicle, calculating a target pressure for at least one tire using at least the tire profile data, establishing a wireless connection with a device separate from the vehicle system, and wirelessly transmitting the target pressure to the other device. Corresponding devices and systems are also disclosed.

### TECHNICAL FIELD

The present disclosure relates generally to vehicle tires and related monitoring systems, and more particularly to systems for establishing the pressure of vehicle tires.

### BACKGROUND

A conventional tire pressure monitoring system (TPMS) includes TPMS sensors mounted within each tire. TPMS sensors periodically generate tire pressure values and transmit them to a central TPMS receiver node. A conventional TPMS sensor includes an RF transmitter and LF receiver. The RF transmitter transmits tire pressure readings to a central TPMS node at a relatively high frequency (300-400 MHz). The LF receiver can receive input signals at a relatively low frequency (125 kHz). Tire pressure values received at a central node can be displayed to a driver and/or compared to predetermined limits to indicate when a low pressure state exists.

Air machines are known that can automatically inflate or deflate tires to a desired pressure. A user connects the air machine to the tire and enters a desired pressure. The air machine includes a built-in pressure gauge and control valve. The machine can increase pressure or decrease pressure until a desired tire pressure is achieved.

### SUMMARY OF DISCLOSURE

Embodiments can include systems, devices and methods that can generate a target pressure for vehicle tires that is based on tire profile data that goes beyond a default pressure setting. Tire profile data can include, but is not limited to, tire make (e.g., manufacturer, warranty) data, tire history data (e.g., mileage, previous inflation levels), vehicle use data (e.g., tire position, vehicle loads), and past and/or present environment data (temperature, season). Based on tire profile data, a target pressure can be generated and wirelessly transmitted during a tire filling operation.

### BRIEF DESCRIPTION OF THE DRAWINGS

FIGS. 1A to 1F are diagrams showing tire filling systems according to various embodiments.

FIGS. 2A and 2B are diagrams showing tire filling systems according to other embodiments.

FIG. 3 is a block diagram of a profile based tire filling system according to an embodiment.

FIG. 4 is a block schematic diagram of an integrated circuit (IC) device according to an embodiment.

FIG. 5 is a diagram of an IC device according to an embodiment.

FIG. 6 is a flow diagram of a profile based tire filling method according to an embodiment.

FIG. 7 is a flow diagram of a profile based tire filling method according to another embodiment.

FIG. 8 is a block diagram of a tire pressure sensor according to an embodiment.

FIG. 9 is a diagram of a valve stem assembly according to an embodiment.

FIG. 10 is a flow diagram of a method according to a further embodiment.

FIGS. 11A and 11B are diagram of tire position determining operations according to embodiments.

FIG. 12 is a flow diagram of a method according to another embodiment.

FIG. 13 is a block diagram of a “smart” filler device according to an embodiment.

FIGS. 14A and 14B are diagrams of smart filler devices according to embodiments.

FIG. 15 is a flow diagram of a method according to another embodiment.

### DETAILED DESCRIPTION

According to embodiments, a system can include a vehicle and tire filling device. Vehicle tires can wirelessly transmit tire pressure values to a vehicle system. A vehicle system can calculate target tire pressure values based on tire profile data which extends beyond simple pressure values for the tires. In a filling operation, target tire pressure values can be wirelessly transmitted by the vehicle. In some embodiments, target tire pressure values can be wirelessly transmitted by the vehicle and received by a tire filling device that can have wireless communication capabilities. In some embodiments, target tire pressure values can be transmitted by the vehicle and received by a user device.

In other embodiments, a user device can receive tire profile data and calculate target tire pressure values. In some embodiments, target tire pressure values can be wirelessly transmitted by the user device and received by a tire filling device that can have wireless communication capabilities.

In other embodiments, a tire sensor can receive tire profile data and calculate target tire pressure values. In some embodiments, target tire pressure values can be wirelessly transmitted by the tire sensor and received by a tire filling device that can have wireless communication capabilities. In some embodiments, target tire pressure values can be wirelessly transmitted by the tire sensor and received by a user device.

In some embodiments, tires of a vehicle can transmit pressure values. In a tire filling operation, a tire being filled can be detected by a system by monitoring for predetermined changes in tire pressure (e.g., increase in pressure, decrease in pressure, or combination thereof).

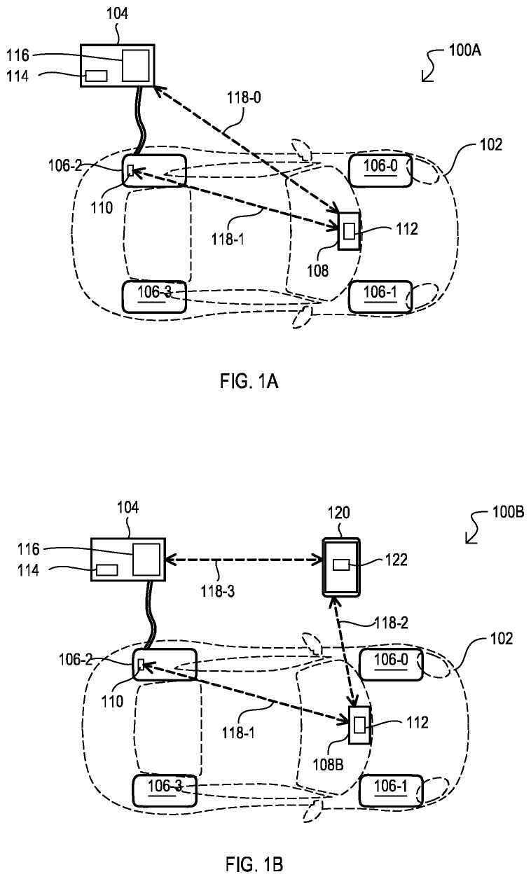

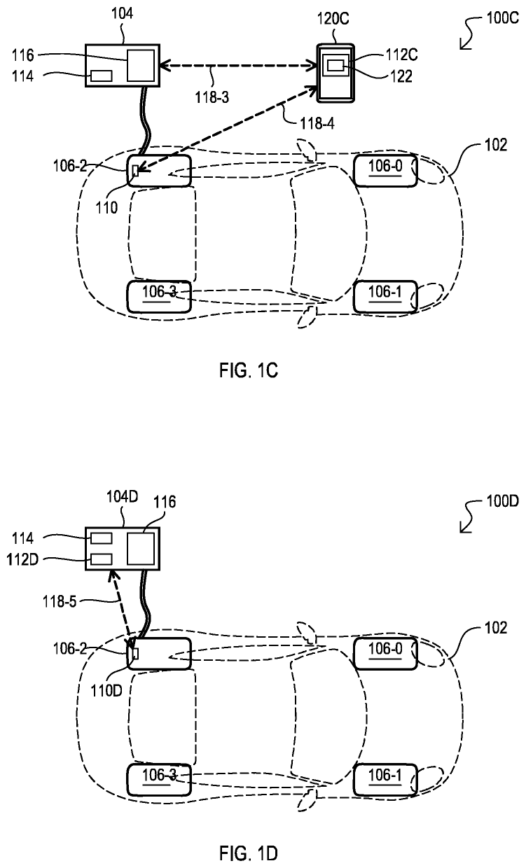

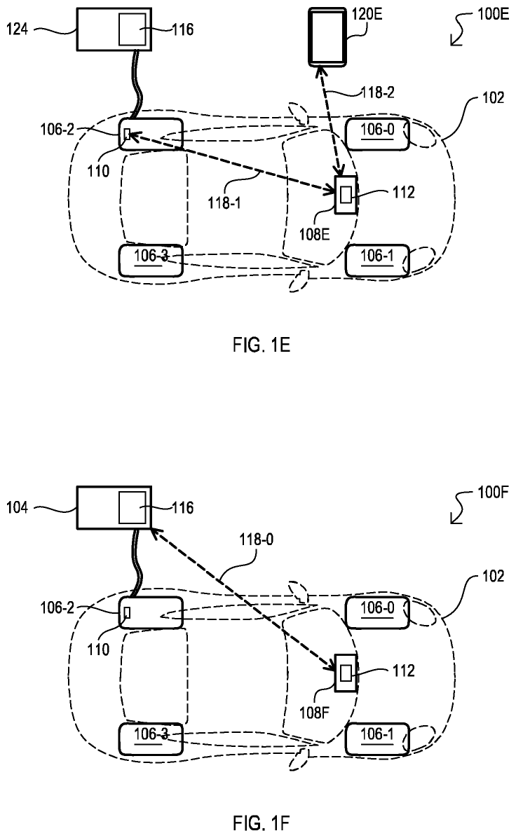

FIGS. 1A to 1E are diagrams of tire filling systems according to various embodiments.

FIG. 1A shows a system 100A in which a vehicle can calculate a profile-based target pressure for its tires, and wirelessly transmit such pressure values to a “smart” filling device. A “smart” filling device and/or vehicle can determine which tire is being filled. A smart filing device can then fill the tire its indicated target pressure.

A system 100A can include a vehicle 102 and a smart filling device 104. A vehicle 102 can include tires 106-0 to 106-3 and in-vehicle processing circuits 108. Tires (106-0 to 106-3) can include tire sensors (one shown as 110) capable of wirelessly transmitting pressure values and otherwise communicating with systems of vehicle 102. Processing circuits 108 can include a profile based target pressure calculator 112. Processing circuits 108 may also be capable of wireless communications with other devices and/or systems. Such wireless communications can be according to one or more standards, including but not limited to a Bluetooth (BT) standard (including BLE), one or more IEEE 802.11 wireless standards (referred to herein collectively as Wi-Fi), a cellular communication standard and/or a proprietary standard of vehicle manufacturer.

A smart filling device 104 can include a fill controller 114 and filling apparatus 116. A fill controller 114 can establish wireless communications to enable the receipt of target pressure values and any other suitable data included in a tire filling operation. In some embodiments, a fill controller 114 can have wireless circuits compatible with any of those described herein. A filling apparatus 116 can be capable of inflating and deflating a tire. In some embodiments, a filling apparatus 116 can be capable of any of: automatically ceasing filing operations once a target pressure is reached, wirelessly communicate filling operation steps (e.g., start of filling, end of filling, periodic pressure readings).

Referring still to FIG. 1A, having described general system components, a tire filling operation will now be described. A smart filling device 104 can issue wireless transmissions indicating its presence and capabilities. Such transmissions can take any suitable form, including but not limited to BT advertisements and/or Wi-Fi broadcasts. A processing circuits 108 can detect the presence of the smart filling device 104 and the two can establish a wireless connection 118-0. In some embodiments, such an operation can include establishing a secure connection using any suitable authentication/encryption method, including those based on a public key infrastructure (PKI). In addition or alternatively, a processing circuits 108 can transmit advertisements/broadcasts that are received and responded to by a smart filling device 104.

In vehicle processing circuits 108 can transmit profile-based target tire pressure values to smart filling device 104 over connection 118-0. A smart filling device 104 can fill a tire to its indicated target pressure and then stop filling operations. In some embodiments, a smart filling device 104 can report to vehicle 102 various actions of the filling operation over connection 118-0.

A system 100A may also include wireless connections between each tire sensor 110 and vehicle processing circuits 108 (one such connection shown as 118-1). A connection 118-1 can be used to periodically report tire pressure to processing circuits 108. In some embodiments, such a connection can be used to report tire pressure during a tire filling operation, including a tire sensor 110 increasing a sampling/transmission rate and/or transmitting data on target tire pressure (e.g., target tire pressure has been reached, is about to be reached and/or is exceeded).

Connections 118-0/1 can also be used to establish which tire is currently connected to a smart filling device 104. Examples of determining which tire is being filled are described in more detail herein.

In this way, a system can include a vehicle that can calculate a profile-based target tire pressure for tires, and wirelessly transmit such target values to a smart filing device. A smart filling device can then inflate or deflate tires to their calculated target tire pressure.

FIG. 1B shows a system 100B in which a vehicle can calculate a profile-based target pressure for its tires, and wirelessly transmit such pressure values to a user device. A user device can communicate with a smart filling device to automatically fill tires to the calculated target pressures.

A system 100B can include items like those of FIG. 1A, and such like items are referred to by the same reference characters. FIG. 1B can differ from FIG. 1A in that a system 100B can further include a user device 120. A user device 120 can include any suitable device, including but not limited to a smart phone, tablet computing device, or wearable computer device. A user device 120 can wirelessly communicate with in-vehicle processing circuits 108 and smart filling device 104. A user device 120 can store profile based target pressure values 122 received from processing circuits 108 and transmit such target pressure values 122 to a smart filling device 104. In some embodiments, a user device 120 can include an application executable to provide any or all of the various user device 120 functions described herein.

A tire filling operation for system 100B will now be described. A user device 120 can receive profile based target pressure values 122 from vehicle processing circuits 108B over a wireless connection 118-2. Such an action can occur prior to, or during a tire filling operation.

A smart filling device 104 and/or user device 120 can advertise/broadcast to establish a wireless connection 118-3 as described herein or equivalents. Over connection 118-3, user device can transmit profile based target tire pressure values to smart filling device 104. A smart filling device 104 can fill a tire to its indicated target pressure and then end filling operations. In some embodiments, a smart filling device 104 can report to a user device 120 various actions of the filling operation over connection 118-3.

Connections 118-1/2/3 can also be used to establish which tire is currently connected to a smart filling device 104, as described in more detail herein.

In this way, a system can include a user device can receive profile based target pressure values, and wirelessly transmit such values to a smart filing device, which can automatically inflate the tires to their calculated target tire pressure.

FIG. 1C shows a system 100C in which a user device can calculate a profile based target pressure for tires of a vehicle. The user device can then communicate with a smart filling device to automatically fill tires to the calculated target pressures.

A system 100C can include items like those of FIG. 1B, and such like items are referred to by the same reference characters. FIG. 1C can differ from FIG. 1B in that a user device 120C can establish a wireless connection with tires (106-0 to -3) (one shown as 118-4). A user device 120C can receive profile data for tires and include a profile based target pressure calculator 112C.

A tire filling operation for system 100C will now be described. A smart filling device 104 and/or user device 120C can establish a wireless connection 118-3 as described herein or equivalents. Over connection 118-3, user device 120C can transmit profile based target tire pressure values to smart filling device 104. A smart filling device 104 can fill a tire to its indicated target pressure and then end filling operations. In some embodiments, a smart filling device 104 can report to a user device 120 various actions of the filling operation over connection 118-3.

Connections 118-3/4 can also be used to establish which tire is currently connected to a smart filling device 104, as described in more detail herein.

In this way, a system can include a user device that can receive profile based target pressure values, and wirelessly transmit such values to a smart filing device, which can automatically inflate the tires to their calculated target tire pressure.

FIG. 1D shows a system 100D in which a smart filling device can receive tire profile data from tires of a vehicle. The smart filling device can calculate a profile-based target pressure for tires of a vehicle, and automatically fill tires to the calculated target pressures.

A system 100D can include items like those of FIG. 1A, and such like items are referred to by the same reference characters. FIG. 1D can differ from FIG. 1A in that a smart filling device 104D can include a profile based target pressure calculator 112D. Further, a smart filling device 104D can wirelessly communicate with tires to receive profile data for the tires. Tire sensors (e.g., 110) can store profile data and wirelessly transmit such profile data to smart filling device 104D.

A tire filling operation for system 100D will now be described. A smart filling device 104D can establish a wireless connection (e.g., 118-5) with tire sensors 110D in each tire as described herein or equivalents. Over such a connection 118-5, a tire sensor 110D can transmit profile data to a smart filling device 104D. A smart filling device 104D can calculate profile based pressure values for each tire and fill such tires to their indicated target pressure. In an alternate embodiment, a tire sensor 110D can receive profile data from other tires, and calculate a profile based target pressure value for the tires and transmit such data to smart filling device 104D over connection 118-5. In still another embodiment, each TPMS sensor can store its own profile data, and calculate its own target pressure, and communicate such a target pressure to a smart filling device 104D.

In this way, a system can include tires in communication with a smart filling device to calculate a profile based target pressure for each tire. Tires can store and wirelessly transmit profile data for enabling a profile based tire pressure calculation. The profile based tire pressure calculation for multiple tires can be performed by a smart filling device, by one tire sensor in communication with other tire sensors, or by each tire sensor for its own tire.

FIG. 1E shows a system 100E that includes a manual filling device. A vehicle and/or user device can calculate profile based target pressure values for tires of a vehicle. Such values can be presented to a user by a system of the vehicle and/or by a user device.

A system 100E can include items like those of FIG. 1A, and such like items are referred to by the same reference characters. FIG. 1E can differ from FIG. 1A in that a filling device 124 can be manual device that cannot receive target pressure values over a wireless connection. In vehicle processing circuits 108E can provide profiled based target pressure values to a user in any suitable manner (e.g., a visual display, audio message). In addition or alternatively, a user device 120E can provide profiled based target pressure values to a user.

A tire filling operation for a system 100E will now be described. Vehicle processing circuits 108E can be placed into a tire filling mode. Such an action can be in response to a user input (e.g., request) and/or a vehicle condition (e.g., tire below a preset pressure threshold). In a tire filling mode, processing circuits 108E can calculate profile based target pressure values for each tire. Such an action can include receiving data from tires via a wireless connection 118-1. Target pressure values can be presented to a user by processing circuits 108E. In some embodiments, processing circuits 108E can monitor a pressure of each tire (106-0 to -3), and provide feedback on the filling operation. In addition or alternatively, target pressure values and/or feedback can be provided by a user device 120E. Such feedback by a user device 120E can utilize wireless connections 118-1/2.

In this way, a system can include in vehicle processing circuits calculating profile based tire pressure values and providing such values to a user through a vehicle system and/or user device in wireless communication with the vehicle processing circuits.

FIG. 1F shows a system 100F in which a vehicle system can communicate with a smart filling device to automatically fill tires to calculated target pressures.

A system 100F can include items like those of FIG. 1A, and such like items are referred to by the same reference characters. FIG. 1F can differ from FIG. 1A in that vehicle processing circuits 108F can communicate with smart filling device 104 without having to communicate with a tire sensor 102.

A smart filling device 104 and/or vehicle processing circuits 108F can advertise/broadcast to establish a wireless connection 118-0 as described herein or equivalents. Over connection 118-0, vehicle processing circuits can transmit profile based target tire pressure values to smart filling device 104. A smart filling device 104 can fill a tire to its indicated target pressure and then end filling operations. In some embodiments, a smart filling device 104 can transmit tire pressure values to vehicle processing circuits 108F during the filling operation and/or report to vehicle processing circuits 108F various actions of the filling operation over connection 118-0.

In this way, a system can include vehicle processing circuits wirelessly transmit profile based target pressure values to a smart filing device, which can automatically inflate the tires to their calculated target tire pressures.

Embodiments can include automobile systems that include processing circuits that can store tire profile data and calculate profile based tire pressure values using such tire profile data. As noted herein, tire profile data extends beyond a predetermined tire pressure. Processing circuits can be resident in any suitable system of a car.

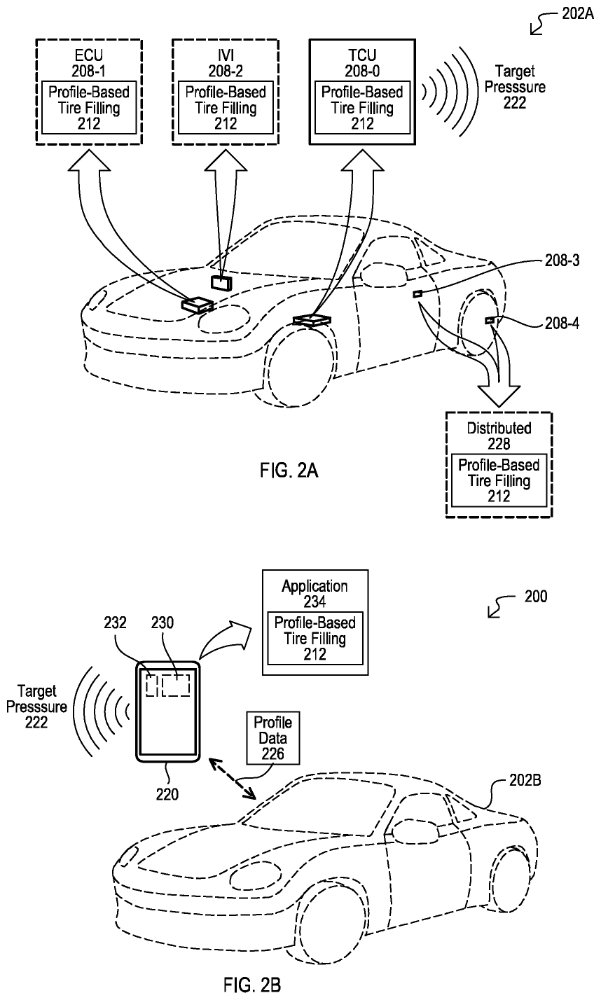

FIG. 2A is a diagram showing vehicle processing circuits for enabling profile based tire pressure filling operations according to embodiments. FIG. 2A shows a vehicle system 202A that can include various systems, including but not limited to a TCU 208-0, ECU 208-1, IVI 208-2 and other ancillary systems 208-3 and 208-4. A TCU 208-0 can provide wireless connection for the vehicle system 202A over cellular networks according to one or more cellular standards. In addition, a TCU 208-0 can provide wireless communications according to one or more other wireless standards (e.g., Wi-Fi, BT) for communicating with a smart filling device or user device to relay target pressure values 222, as described herein and equivalents. A TCU 208-0 can store profile data for calculating profile based tire pressure values and/or receive such values from other systems of the vehicle 202A, including tires and/or tire sensors. Processing circuits within TCU 208-0 can include (e.g., be configured as) a profile based tire filling function 212. Such a function 212 can include calculating profile based tire pressure values, transmitting reported tire pressures in filling operations, receiving tire pressure values in a filling operation.

In addition or alternatively, an IVI 208-2 and/or ECU 208-1 may include processing circuits that provide profile based tire pressure filling functions 212 as described herein. An IVI 208-2 can include various systems for providing entertainment functions, including but not limited to, a display, a radio, and systems for accessing and monitoring vehicle functions. In some embodiments, an IVI 208-2 may also include wireless circuits for establishing connections with other devices in a filling operation (e.g., smart filling device, user device, tire sensors, other systems). An ECU 208-1 can control one or more subsystems of the vehicle, including but not limited to a motor/engine, power train, transmission, brake, body and/or suspension. In some embodiments, and ECU 208-1 may have wireless communication capabilities.

In some embodiments, profile based tire filling functions can be distributed 228 across one or more systems, including ancillary systems (e.g., 208-0 to 208-4). Ancillary systems 208-3/4 can include processing and other circuits having other functions in an automobile (e.g., door/trunk controls/sensors, body cameras, tire sensors, mirror/window controllers, radar systems, light controllers). Functions distributed over multiple systems can include, but are not limited to, calculating target pressure values, storage of profile data and establishing wireless connections with other systems.

In this way, functions for profile based tire filling operations can be included and/or distributed over any suitable system of a vehicle.

Embodiments can include user devices in communication with automobile systems that include processing circuits that can store tire profile data and calculate a profile based tire pressure using the tire profile data.

FIG. 2B is a diagram showing a system 200 with a vehicle system 202B and a user device 220. A user device 220 can receive profile data 226 from a vehicle 202B. Profile data 226 can include tire profile data and/or user profile data, as descried herein or equivalents. A user device 220 can include processing circuits 230 for calculating target pressure values 222 using profile data 226. A user device 220 can also include wireless circuits 232 for establishing connections with other devices in a profile based tire filling operation and related operations. Wireless circuits 232 can transmit target pressure data 222 to a smart filler device, for example. In some embodiments, all or a portion of profile based filing operations 212 can be performed by an application 234 resident on a user device 220.

In this way, functions for profile based tire filling operations can be performed by a user device in communication with a vehicle.

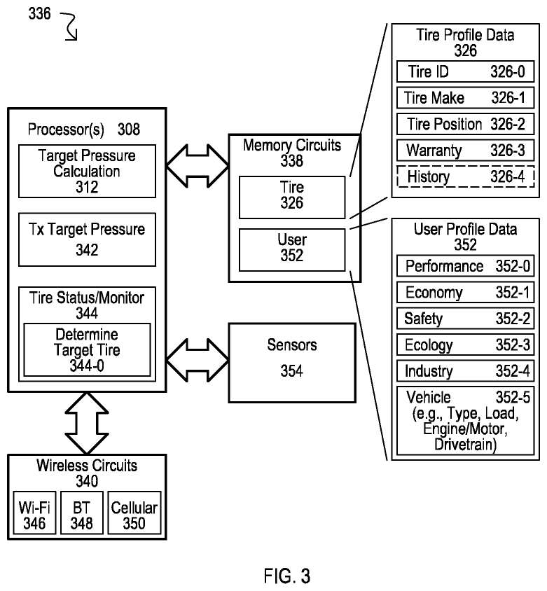

FIG. 3 is a block schematic diagram of profile based tire filling system 336 according to an embodiment. A system 336 can include a processor circuits 308, memory circuits 338, wireless circuits 340, and optionally, sensor circuits 354. Processor circuits 308 can include one or more processors for executing functions related to profile based tire filling operations. Processor circuits 308 can include a target pressure calculator 312, a transmit target pressure function 342, and optionally, a tire status and monitor function 344. Target pressure calculator 312 can calculate a target pressure value for a tire using any of tire profile data 326 and optionally, any of user profile data 352, or data from sensor circuits 354. A transmit target pressure function 342 can transmit target pressure values to other devices, such as a smart filling device or a user device. Such functions can utilize wireless circuits 340. A tire status/monitor function 344 can monitor a status of tires, including periodically receiving tire pressure readings from tire sensors, or the like. In the embodiment shown, tire status/monitoring function 344 can determine a target tire 344-0 (i.e., a target that is subject to a tire filling operation). As will be described in more detail herein, determining a target tire 344-0 can include the use of wireless circuits 340.

Memory circuits 338 can store tire profile data 326 and user profile data 352. Tire profile data 326 can include, but is not limited to, tire identification (ID) data 326-0, tire make data 326-1, tire position data 326-2, tire warranty data 326-3, and tire history data 326-4. Tire ID data 326-0 can be values unique to a tire (e.g., serial number). Tire make data 326-1 can be manufacturer data for a tire. Tire position data 326-2 can indicate a current location of a tire on a vehicle. A tire location value can be determined according to various techniques described herein. Warranty data 326-2 can include warranty data for a tire. In some embodiments, warranty data can be accessed via a server or the like using tire ID and/or tire make information. Warranty data 326-2 can include dynamic values that change due to time and/or mileage on a corresponding tire. History data 326-4 can be accumulated for tires over time, and can include, but is not limited to, mileage, events (e.g., high acceleration events), temperature history, or pressure history.

User profile data 352 can be data selected by a user that can result in changes in desired tire pressure. User profile data 352 can include, but is not limited to, performance data 352-0, economy data 352-1, safety data 352-2, ecology data 352-3 and industry data 352-4. Performance data 352-0 can correspond to a desired vehicle performance, including but not limited to, traction, ride experience, acceleration and/or deceleration. Economy data 352-1 can correspond to energy use (battery usage, fuel consumption). Safety data 352-2 can be a subset of performance data 352-0, and can correspond to vehicle response for higher safety. Ecology data 352-3 can corresponding to impact on the natural environment and can overlap with economy. Industry data 352-4 can correspond to the anticipated use of the vehicle (e.g., consumer, industrial, civil service). In some embodiments, user profile data 352 can also include vehicle related data 352-5. Such data can be related to the vehicle on which the tires are mounted, and can include essentially fixed values (e.g., vehicle type, engine/motor, drivetrain) as well as values that may change and/or be historical (e.g., load).

Sensor circuits 354 can detect an environment of a vehicle and provide environment data that may optionally be used for a profile based target pressure calculation 312. Environment data can include, but are not limited to, temperature, atmospheric pressure, geographic location, and wireless environment (e.g., noise level, signal power).

In this way, a profile based tire filling system can utilize various profile factors, including tire manufacturer data, to calculate target pressure for tires.

While systems according to embodiments can take any suitable form, including systems with multiple components, some embodiments can be advantageously compact single integrated circuit devices capable of providing wireless communications according to multiple standards.

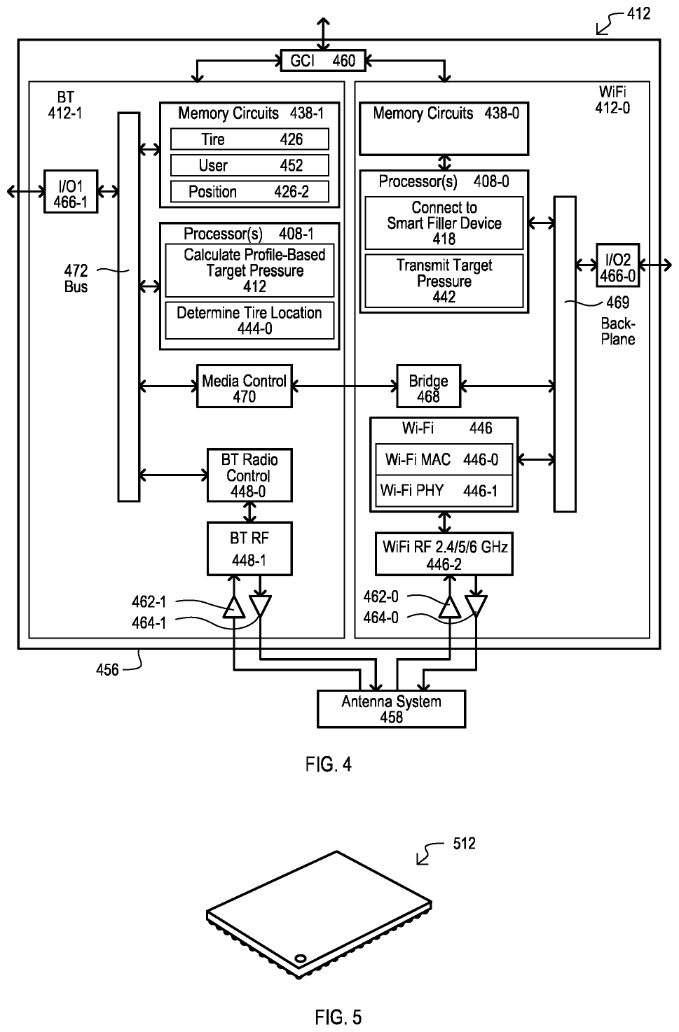

FIG. 4 is a block diagram of a profile based tire filling system 412 according to another embodiment. In some embodiments, a system 412 can be an implementation of any of those shown herein, or equivalents. A system 412 can include a single integrated circuit (IC) device 456 that can connect to an antenna system 458. IC device 456 can include a Wi-Fi section 412-0, a BT section 412-1, a coexistence interface (GCI) 460, power amplifiers (PAs) 462-0, 462-1 and low noise amplifiers (LNAs) 464-0, 464-1.

A Wi-Fi section 412-0 can include processor circuits 408-0, memory circuits 438-0, first input/output (IO) circuits 466-0, bridge control circuit 468 and Wi-Fi circuits 446 connected to one another over a backplane 469. Processor circuits 408-0 can include one or more processors that execute instructions for Wi-Fi operations, including creating connections 418 with smart filling devices and transmitting target pressure values 442 to such devices. Such functions can occur as described for embodiments herein and equivalents. A memory section 438-0 can include memory circuits for storing data accessible by a system 412, including by processor circuits 408-0, including instructions executable by processor circuits 408-0 to provide the described functions.

First IO circuits 466-0 can enable communication with the system 412 according to any suitable interface, including a serial interface or parallel interface. In some embodiments, first IO circuits 466-0 can be compatible with one or more serial standards, including but not limited to: an SPI standard, I²C standard, USB standard, CAN bus, PCI Express and/or a proprietary standard.

Wi-Fi circuits 446 can include circuits for performing wireless communications according to one or more IEEE 802.11 wireless standards, including those operating in the 2.4, 5 or 6 GHz band. In some embodiments, this can include IEEE 802.11 compatible media access control layer (MAC) circuits 446-0 and IEEE 802.11 compatible physical interface layer (PHY) circuits 446-1. Wi-Fi RF circuits 446-2 can include multi-band radio circuits that transmit and receive data on one or more Wi-Fi bands. In the embodiment shown, Wi-Fi RF circuits 446-2 can drive one or more PAs 462-0 and receive input signals from on one or more LNAs 464-0.

BT section 412-1 can provide wireless communications according to one or more BT standards. BT section 412-1 can include processor circuits 408-1, memory circuits 438-1, media control circuits 470, second IO circuits 466-1, and BT radio control circuits 448-0 connected to one another by a bus 472.

Processor circuits 408-1 can perform various operations related to profile based tire filling, including but not limited to calculating profile based target pressure values 412 and/or determining tire location 444-0. Memory circuits 438-1 can store data for executing other wireless operations, including instructions executable by processor circuits 408-1. In some embodiments, memory circuits 438-1 can store tire profile data 426, user profile data 452 and/or tire position data 426-2.

BT RF circuits 448-1 can be controlled by BT radio control circuits 448-0 and can include radio circuits to enable transmission of messages according to one or more BT standards. In the embodiment shown, BT RF circuits 448-1 can drive one or more PAs 462-1 and receive input signals from one or more LNAs 464-1.

Media control circuits 470 can communicate with Wi-Fi section 412-0 using bridge control circuits 468 to control access to a transmission media (e.g., 2.4 GHZ band). In some embodiments, such a communication path can be used by processor circuits 408-1 to transfer target pressure values to Wi-Fi section 412-0. Second IO circuits 466-1 can enable communication with system 412 according to any of the embodiments described herein or equivalents.

Wi-Fi section 412-0 and BT section 412-1 can be in communication with a coexistence interface 460. A coexistence interface 460 can enable Wi-Fi section 412-0 and BT section 412-1 to interface with other wireless systems, such as cellular network systems, including but not limited to 3G, 4G, LTE and 5G networks.

In some embodiments, a BT section 412-1 can be in communication with BT based tire sensors to receive tire pressure information, and in some embodiments, tire manufacturer information (e.g., tire pressure, tire make) and/or tire position information. While FIG. 4 shows memory circuits 438-1 storing profile and position data (426, 452, 426-2), any or all of such data can be stored in memory circuits 438-0 of Wi-Fi section 412-0, or in other memory circuits (not shown).

FIG. 5 shows a packaged single chip system 512 which can include a profile based tire filling system as described herein, or equivalents. In some embodiments, system 512 can include those circuits shown in FIG. 4.

In this way, a single integrated circuit device can provide real world to virtual wireless relay operations.

While embodiments can include the various methods described for profile based tire filling systems and described herein, additional methods will now be described with reference to flow diagrams.

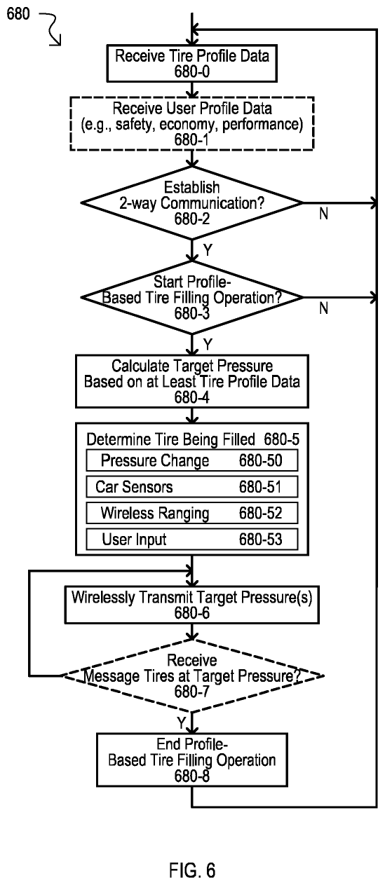

FIG. 6 is a flow diagram of a profile based tire filling method 680 according to an embodiment. In some embodiments, a method 680 can be executed by a system in conjunction with a smart filler device. Such a system can include a vehicle based system and/or a user device (e.g., an application executed on a user device).

A method 680 can include receiving tire profile data 680-0. Such an action can include receiving tire profile data in any suitable fashion, including but not limited to: a user entering tire profile data and/or such data being automatically read by a system. Optionally, a method 680 can include receiving such data as described for tire profile data.

A method 680 can attempt to establish two-way communication with a filling device 680-2. Such an action can include establishing a connection according to a wireless protocol, including but not limited to Wi-Fi and/or BT. If two-way communication cannot be established (N from 680-2), a method 680 can return to receiving tire profile data 680-0. If two-way communication can be established (Y from 680-2), a method 680 can attempt to start a profile based tire filling operation 680-3. Such an action can include exchanging data with a filing device to determine if the smart device is properly operating and is compatible with a system. If a filling operation cannot be started (N from 680-3), a method 680 can return to receiving tire profile data 680-0.

If a filling operation can be started (Y from 680-3), a method 680 can calculate a target pressure value for one or more tires using at least tire profile data 680-4. Such an action can include processing circuits of a system calculating a target pressure using tire profile, and optionally user profile data, as described herein or equivalents. It is understood such a calculation can include any suitable computation system. Further, such calculations can be performed remote from a vehicle and/or user device, such as by a remote server, or the like. A target pressure calculation can take any suitable form, and in one embodiment can include a tire condition calculation. For example, a Tire Condition formula could take the form of:

$$Tire Condition ( Vehicle type ) = \frac{1}{( Warranty Miles - Current Miles )} * Vt + \frac{1}{( Warranty Age - Current Age )} * Vt ,$$

where Vt, is a vehicle type.

However, such a calculation is provided by way of example only and should not be construed as limiting.

A method 680 can include determining which tire is being subject to a filling operation 680-5. Such an action can include any suitable methods, including but not limited to detecting a pressure change 680-50, utilizing car sensors 680-51, wireless ranging 680-52, or a user input 680-53. Detecting a pressure change 680-5 can include a user or filling machine inflating, deflating or both inflating and deflating a tire so that the vehicle can identify a tire (e.g., by pressure changes relayed by a tire sensor or the like). Car sensors 680-51 can include any suitable car sensor that can locate a user and/or filling nozzle within proximity to a tire, including but not limited to car cameras and/or ranging systems such as radar or lidar. Wireless ranging 680-52 can include any suitable ranging operation according to the wireless systems/standards of a vehicle, including but not limited to: measuring angle of attack (AoA), a received signal strength indicator (RSSI) or channel sounding (CS). User input 680-53 can include a user identifying a tire, and can include entering data in a vehicle system (e.g., touch screen) and/or a user device.

In addition or alternatively, a smart filling device can determine a tire position and provide such data to a system (e.g., vehicle or user device). The system can use such data as the tire location and/or use such data to confirm tire location.

A method 680 can include transmitting a target tire pressure 680-6. Such an action can include wirelessly transmitting one or more target pressure values over the established 2-way communication path. Optionally, a method 680 can include determining if a message is received indicating that the filling operation is complete (i.e., the tire is at a desired target pressure) 680-7. If such a message is not received (N from 680-7), a method 680 can continue to transmit a target pressure 680-6. If such a message is received (Y from 680-7), a method 680 can end a profile based tire filling operation 680-8.

In this way, a system can execute an automatic tire filling operation with a smart filling device to fill tires to a profile based target pressure.

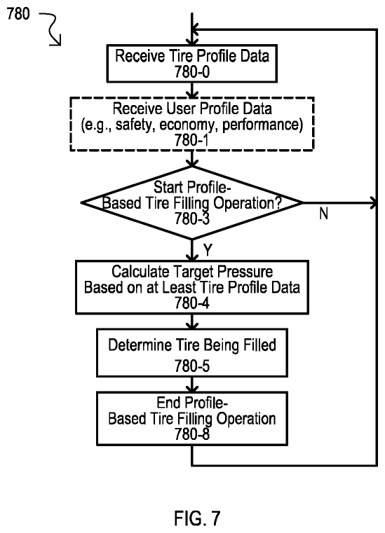

FIG. 7 is a flow diagram of a profile based tire filling method 780 according to another embodiment. A method 780 can be executed by a system in conjunction with a non-automated filling device. Such a system can include a vehicle based system and/or a user device (e.g., an application executed on a user device).

A method 780 can include actions like those shown in FIG. 6, and such like actions are referred to with the same reference characters, but with the leading digit being a “7” instead of “6” (i.e., 780-0, 780-1, 780-3, 780-4, 780-5, 780-8).

In this way, a system can execute an automatic tire filling operation with a non-automatic filling device to fill tires to a profile based target pressure.

While embodiments can include systems for controlling a profile based tire filling operation, embodiments can also include sensors utilized in such operations.

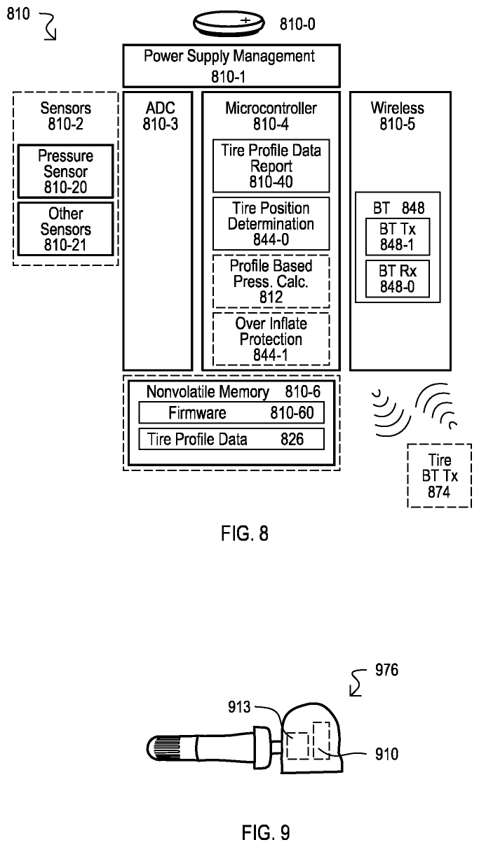

FIG. 8 is a block diagram of a tire sensor 810 according to an embodiment. In some embodiments, a tire sensor can be compatible with a TPMS.

A tire sensor 810 can include a battery 810-0, a power supply management circuit 810-1, sensors 810-2, an analog-to -digital converter circuit (ADC) 810-3, a microcontroller 810-4, wireless circuits 810-5 and nonvolatile memory circuits 810-6. Sensors 810-2 can include various sensors for detecting features of a tire, including but not limited to a pressure sensor 810-20 and other sensors 810-21. Other sensors 810-21 can include but are not limited to temperature sensors and accelerometers. ADC 810-3 can convert analog signals received from sensors 810-2 into digital values, including converting tire pressure readings into digital values for transmission.

A microcontroller 810-4 can be programmed to execute various functions, including but not limited to reporting tire profile data 810-40, executing tire position determination operations 844-0, and optionally, executing all or a portion of a profile based tire pressure calculation 812 and/or executing an over inflation protection operation 844-1. Reporting tire profile data 810-40 can include periodically reporting tire pressure readings, as well as any other data that can be included in a profile based tire pressure calculation. Accordingly, reporting tire profile data 810-40 can further include reporting any of the tire profile data and/or user profile data described herein and equivalents. In some embodiments, reporting tire profile data 810-40 can vary according to mode of operation. In a standard mode, tire profile data can be reported over relatively long periods of time. However, in a tire filling operation, tire profile data can be reported at a higher frequency.

A tire position determination function 844-0 can include a sensor 812 participating in a wireless ranging operation using wireless circuits 810-5. Such a ranging operation can involve one or more other systems of a vehicle, as will be described herein in more detail. Profile based pressure calculation 812 can take the form of any of those described herein, including a distributed calculation involving one or more other vehicle systems.

An over inflation protection operation 844-1 can monitor sensed tire pressure, and compare such pressure to a limit, which may be a target tire pressure, but can also be a target tire pressure plus some margin. In the event a tire pressure exceeds the limit, over inflation protection operation 844-1 can activate an inflation stop signal, and optionally, a deflation signal.

Wireless circuits 810-5 can include wireless circuits for transmitting tire profile data acquired by the sensor 812 as well as receiving tire profile data from a tire. In the embodiment shown, wireless circuits 810-5 can include BT circuits 848. BT circuits 848 can include transmit functions 848-1, which can transmit tire related data. Receive function 848-1 can receive profile data for the tire, including but not limited tire ID, tire make, and tire warranty data. Such profile data can be transmitted from a tire, with tire BT circuits 874.

Nonvolatile memory circuits 810-6 can store data for a sensor 810. Such data can include, but is not limited to, firmware 810-60 for executing by microcontroller 810-4 to provide the various microcontroller functions described. In some embodiments, nonvolatile memory circuits 810-6 can store tire profile data 826.

FIG. 9 is a diagram showing a tire valve stem assembly 976 according to an embodiment. A tire valve stem assembly 976 can include a valve 913 and tire sensor 910 like that shown in FIG. 8, or an equivalent, and can be installed in a tire of a vehicle. A valve 913 can be controlled by tire sensor 910 to inflate or deflate a tire as described for embodiments herein, including but not limited to, inflating a tire to a target pressure, inflate and deflate a tire to identify its location and deflate a tire in the event of over inflation.

In this way, a tire pressure sensor can include circuits for enabling all, or a portion of a profile based tire filling operation.

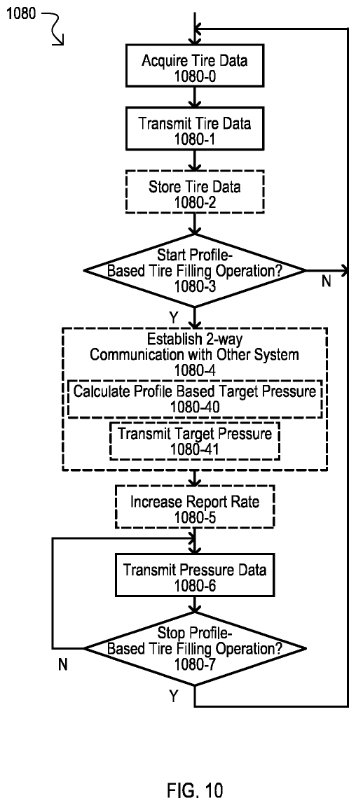

FIG. 10 is a method 1080 according to another embodiment. A method 1080 can be executed by a tire sensor, like that shown in FIG. 8 or 9, or an equivalent. A method 1080 can include acquiring tire data 1080-0. Such an action can include taking sensor readings for a tire, including tire pressure, but can also include any other sensor readings described herein. Tire data can be transmitted 1080-1. Such an action can include transmitting tire data to another system, such as an in-vehicle system (e.g., central TPMS node) or a user device. Optionally, a method 1080 can include storing tire data 1080-2 in circuits local to a tire sensor.

A method 1080 can include determining if a tire filling operation has started 1080-3. Such an action can include sensor receiving a communication from another system, such as an in-vehicle system, user device or a smart filler device. If a tire filling operation is not started (N from 1080-3), a method 1080 can return to acquiring tire data 1080-0.

If a tire filling operation is started (Y from 1080-3), optionally, a method 1080 can establish two-way communications with another system 1080-4. Such communication can be with an in-vehicle system, a user device, a smart filler device, or any combination thereof. In some embodiments, all or a portion of a profile based target pressure calculation can be performed 1080-40. In some embodiments, a method can include transmitting a target pressure 1080-41.

Upon starting a profile based filling operation (Y from 1080-3), a method 1080 may also optionally increase a tire data reporting rate 1080-5. Such an increase in reporting tire data can be a unilateral action by a tire sensor and/or in response to requests from other systems.

In a profile based filling operation (Y from 1080-3), a method 1080 can transmit tire pressure data 1080-6. Such an action can include a tire sensor wirelessly transmitting tire pressure readings as a filling operation is occurring. Such transmissions can be to any suitable system (e.g., in-vehicle, user device, smart filler device).

A method 1080 can determine if a profile based tire filling operation has ended 1080-7. Such an action can be in response to a message from another system, or can be in response to a timeout condition. While a tire filling operation has not ended (N from 1080-7), a method can continue to transmit tire pressure data 1080-6. When a tire filling operation has ended (Y from 1080-7), a method can return to acquiring tire data 1080-0. If a tire sensor was reporting a t an increased rate, it can return to its previous reporting rate.

In this way, a tire pressure sensor can acquire and transmit tire data, and transmit pressure reading during a profile based tire filling operation.

While embodiments can include profile based tire filling operations, embodiments can also include determining a tire position through wireless measurements.

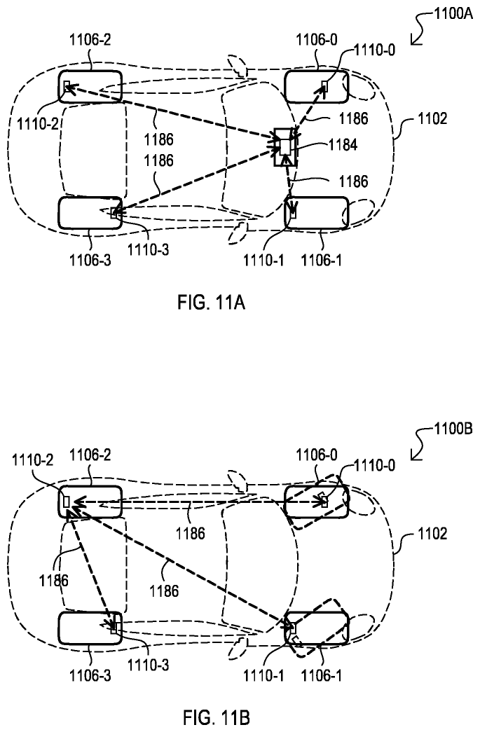

FIG. 11A is a diagram of a vehicle system that can wirelessly determine tire position according to an embodiment. FIG. 11A shows a vehicle system 1100A that includes a vehicle 1102 having tires 1106-0 to 1106-3 and a central node 1184. Each tire (1106-0 to -3) can include a corresponding tire sensor 1110-0 to 1110-3. Tire sensors (1110-0 to -3) and central node 1184 can include wireless circuits with ranging and/or direction finding capabilities. Ranging and/or direction finding operations 1186 can be executed between tire sensors (1110-0 to -3) and a central node 1184. Measurements from ranging/direction finding can be used to determine a tire position. In some embodiments, a position for each tire can be stored in a system of vehicle, in a tire sensor, or both. In some embodiments, a tire position can be assigned to an identifier corresponding to tire sensor (1110-0 to -3) (e.g., a MAC address of BT wireless circuits).

FIG. 11B shows a vehicle system 1100B that can include a vehicle 1102 having tires 1106-0 to 1106-3 with corresponding tire sensors 1110-0 to 1110-3. Tire sensors (1110-0 to -3) can execute ranging and/or direction finding operations 1186 with one another. Measurements from such ranging and/or direction finding can be used to determine a tire position. In some embodiments, front tire position variations from turning can be used in such determinations.

In some embodiments, a position for each tire can be stored in a system of vehicle, in a tire or both. In some embodiments, a tire position can be assigned to an identifier corresponding to tire sensor (e.g., a MAC address of BT wireless circuits).

In this way, tire sensors with or without other vehicle systems can determine a tire position.

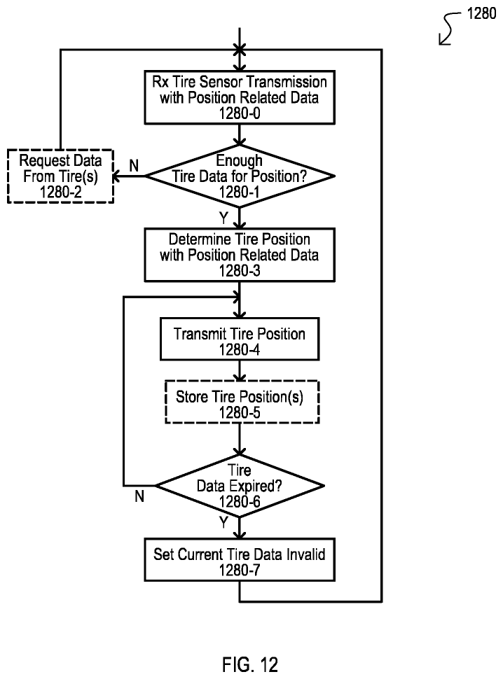

FIG. 12 is a flow diagram of a method 1280 according to another embodiment. A method 1280 can be executed by a tire sensor or central node in a position determining operation. A method 1280 can include receiving tire sensor transmission with position related data 1280-0. Such an action can include any suitable ranging/direction finding operation as disclosed herein, including but not limited to those that use AoA, AoD, RSSI or CS. A method 1280 can determine if enough tire data has been received to determine a tire position 1280-1. If enough data has not been received (N from 1280-1), a method 1280 can return to receiving position related data 1280-0. Optionally, a method 1280 can request data from one or more tires (e.g., tire sensors) 1280-2, which can include data needed to complete a position determination.

If enough data has been received (Y from 1280-1), a method 1280 can determine a tire position with the data 1280-3. A tire position can be transmitted 1280-4. Such an action can include transmitting a tire position to a central node and/or to other tires. Optionally, a tire position can be stored 1280-5. Such an action can include a tire storing its determined position locally. In addition or alternatively, such an action can include a system storing position values with a corresponding identifier for the tire (e.g., MAC address for sensor).

A method 1280 can include determining if current data is expired 1280-6. Such an action can include determining if a predetermined time period has passed. In addition or alternatively, such an action can include an event, such as the start of a tire filling operation. If tire data has not been expired (N from 1280-6), a method can continue to transmit (and optionally store) tire position data 1280-4. If tire data has expired (Y from 1280-6), a method can set current tire positions data as invalid 1280-7 and repeat a position determination operation 1280-7.

In this way, a tire position can be determined with wireless operations to enable such a tire to be filled to its calculated profile based target tire pressure.

While embodiments can include profile based tire filling operations, embodiments can also include tire filler devices and/or methods for profile based tire filling operations.

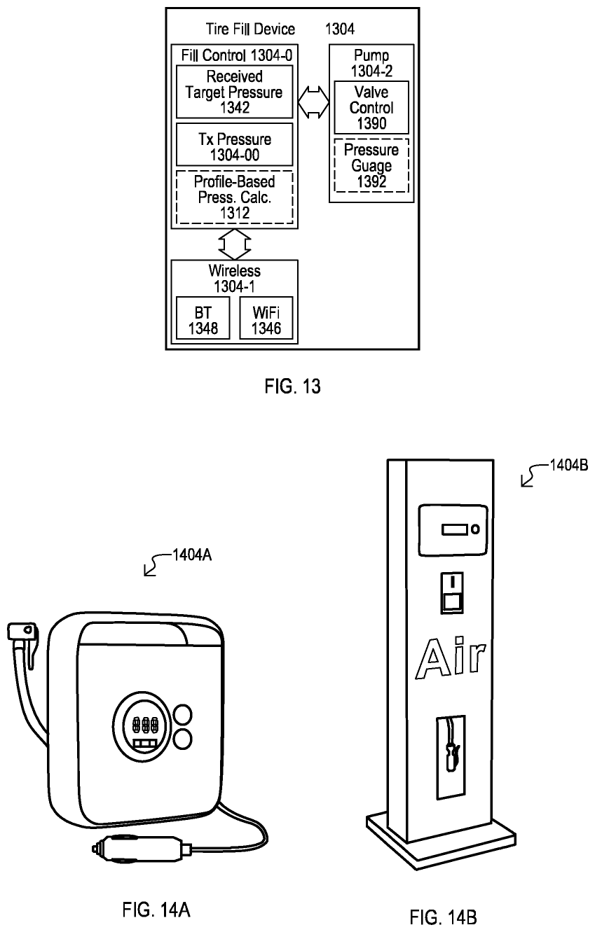

FIG. 13 is a block diagram of a smart filling device 1304 according to an embodiment. A device 1304 can include fill control circuits 1304-0, wireless circuits 1304-1 and a pump section 1304-2. Fill control circuits 1304-0 can include circuits for providing various functions of a profile based tire filling operation, including but not limited to receiving a target pressure 1342. Receiving a target pressure 1342 can include establishing two-way communication with another device/system (e.g., vehicle system, user device, tire sensor) and receiving target pressure values 1342 from such devices/systems. Optionally, fill control circuits 1304-0 can transmit a tire pressure 1304-00 and/or calculate a profile based tire pressure 1312. Transmitting a tire pressure 1304-00 can include transmitting a current pressure reading to a system/device, to enable such a system device to follow a tire pressure during a filling operation. Calculating a profile based target pressure 1312 can include fill control circuits 1304-0 receiving profile data from any suitable device.

Wireless circuits 1304-1 can enable device 1304 two communicate with other devices/systems in a profile based tire filling operation. Wireless circuits 1304-1 can be compatible with any suitable standard, including private standards. In the embodiment shown, wireless circuits 1304-1 can include BT circuits 1348 and Wi-Fi circuits 1346.

Pump section 1304-2 can include a pump for filling tires to a desired pressure. A pump section can include valve control 1390 for enabling the inflation, and in some embodiments, deflation of a tire. In some embodiments, fill control 1304-0 can cause valve control 1390 to deflate and inflate a tire to identify it as a tire being filled. Device 1304 can then receive target pressure values for the identified tire.

FIGS. 14A and 14B are diagrams showing smart filler devices according to embodiments. FIG. 14A shows a portable tire filling device 1404A that can include features shown in FIG. 13. A portable tire filling device 1404A can operate according to batteries, or power provided from a vehicle. FIG. 14B shows a tire filling station 1404B, which can include features of FIG. 13.

In this way, a smart filler device can receive profile based target tire pressure values over a wireless connection, and automatically fill a tire to such target pressures. In some embodiments, a smart filler device can inflate and/or deflate a tire to identify the tire to ensure the target pressure for the tire is received.

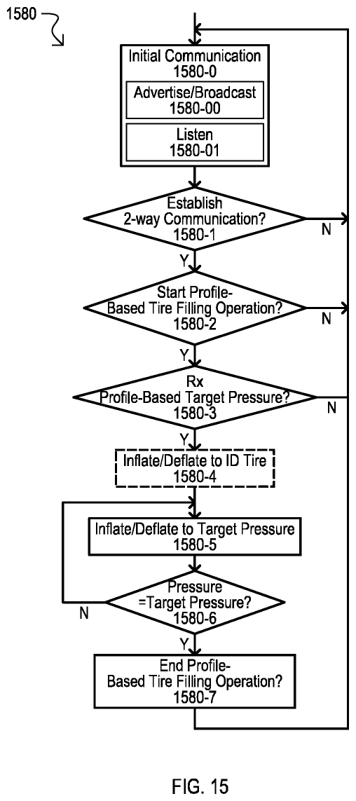

FIG. 15 is a flow diagram of a method 1580 according to another embodiment. A method 1580 can be executed by a smart filler device. A method 1580 can include an initial communication 1580-0. In some embodiments, an initial communication 1580-0 can result in a smart filler device detecting the presence of a vehicle having tires that can be filled to profile based pressure values. In some embodiments, such initial communications can include advertising transmissions and/or broadcast transmissions 1580-00. Such actions can include, but are not limited to, BT advertisements on predetermined advertising channels and/or Wi-Fi broadcasts over one or more predetermined Wi-Fi channels. In addition or alternatively, a method 1580 can include listening for other devices/systems 1580-01 (e.g., listening for the advertisements or broadcasts of such other devices/systems).

A method 1580 can include trying to establish 2-way communications 1580-1. Such an action can include establishing a wireless connection with another system/device, including but not limited to, a vehicle, a tire sensor, or a user device. In some embodiments, establishing 2-way connection can include attempting PKI based authentication. If a 2-way connection cannot be established (N from 1580-1), a method 1580 can return to initial communications 1580-0.

If a 2-way connection can be established (Y from 1580-1), a method 1580 can determine if a profile based tire filling operation is to start 1580-2. Such an action can include, but is not limited to, receiving a message from another device/system and/or a user input, including pressing a button on a device. If a profile based tire filling operation does not start (N from 1580-2), a method can return to initial communications 1580-0.

If a profile based tire filling operation starts (Y from 1580-2), a method can determine if a profile based target pressure has been received 1580-3. Such an action can include any of those described herein, including but not limited to, receiving target pressure values wirelessly from other system/devices or calculating a target pressure using received profile values. Optionally, a method can include inflating/deflating to identify a tire being filled 1580-4. Such an action can be automatic, or in response to a message or user input.

A method 1580 can inflate or deflate a tire to bring it to a target pressure 1580-5. While a target pressure for a tire has not been reached (N from 1580-6), inflation/deflation can continue. Once a target pressure for a tire has been reached (Y from 1580-6), a profile based tire filling operation can end 1580-7.

In this way, a method can make initial communications sensing or indicating the presence of a profile based tire filling service. Two-way communications can be established that provide a profile based target pressure for a tire, and the tire can be filled to the target pressure.

Embodiments can include methods, devices and systems that can include, by operation of a vehicle system, receiving tire profile data for each of a plurality of tires of the vehicle, calculating a target pressure for at least one tire using at least the tire profile data, establishing a wireless connection with a device separate from the vehicle system, and wirelessly transmitting the target pressure to the other device.

Embodiments can include methods, devices and systems can include wireless circuits configured to communicate according to at least one wireless standard, receive tire profile data for tires of a vehicle, and transmit target pressure values for the tires. Memory circuits can be included that are configured to store the tire profile data. Processor circuits can be included that are configured to calculate target pressure for each of the tires using at least the tire profile data.

Embodiments can include methods, devices and systems that can include a plurality of tire sensor circuits, each configured to sense at least a tire pressure for a tire of a vehicle and wirelessly transmit tire pressure data. Memory circuits can be included that are configured to store tire profile data, the tire profile data being different than the tire pressure data. Processor circuits can be included that are configured to calculate a target pressure for each of the tires using at least the tire profile data. Wireless circuits can be included that are configured to wirelessly transmit the target pressure.

Methods, devices and systems according to embodiments can include tire profile data comprising tire manufacturer identification data.

Methods, devices and systems according to embodiments can include tire profile data comprising a mileage value for tires.

Methods, devices and systems according to embodiments can include tire profile data comprising warranty data for tires.

Methods, devices and systems according to embodiments can include, by operation of the vehicle system, receiving user profile data, and calculating the target pressure for each tire using at least the tire profile data and the user profile data.

Methods, devices and systems according to embodiments can include the user profile data being selected from a performance selection, an economy selection and a durability selection.

Methods, devices and systems according to embodiments can include, by operation of the vehicle system, determining a vehicle position of a target tire from the plurality of tires, and wirelessly transmitting the target pressure of the target tire.

Methods, devices and systems according to embodiments can include determining a vehicle position of a target tire by detecting a change in pressure in the target tire.

Methods, devices and systems according to embodiments can include wireless circuits compatible with any of a Bluetooth standard and an IEEE 802.11 wireless standard.

Methods, devices and systems according to embodiments can include tire profile data being selected from tire manufacturer data, tire mileage data and tire warranty data.

Methods, devices and systems according to embodiments can include memory circuits configured to store user profile data. Processor circuits can be configured to calculate a target pressure for each tire using at least the tire profile data and user profile data. User profile data can be selected from a performance selection, an economy selection and a durability selection.

Methods, devices and systems according to embodiments can include wireless circuits, memory circuits and processor circuits that are formed in a same integrated circuit substrate.

Methods, devices and systems according to embodiments can include the memory circuits configured to store user profile data. Processor circuits can be configured to calculate the target pressure for each tire of a vehicle using at least the tire profile data and user profile data. User profile data can be selected from a performance selection, an economy selection and a durability selection.

Methods, devices and systems according to embodiments can include memory circuits and processor circuits being part of a vehicle system.

Methods, devices and systems according to embodiments can include memory circuits and processor circuits being part of a user device separate from the vehicle.

Methods, devices and systems according to embodiments can include processor circuits that are configured to determine which tire is being filled in a tire filling operation.

Methods, devices and systems according to embodiments can include a tire filling device configured to at least inflate a tire of the vehicle. The tire filling device can be configured to receive a target pressure for at least one tire and fill the at least one tire to the target pressures.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
by operation of a vehicle system,
receiving tire profile data for each of a plurality of tires of the vehicle,
calculating a target pressure for at least one tire using at least the tire profile data,
establishing a wireless connection with a device separate from the vehicle system, and
wirelessly transmitting the target pressure to the other device.

2. The method of claim 1, wherein the tire profile data comprises tire manufacturer identification data.

3. The method of claim 2, wherein the tire profile data further comprises a mileage value for the tires.

4. The method of claim 2, wherein the tire profile data further comprises warranty data for the tires.

5. The method of claim 1, further including:
by operation of the vehicle system
receiving user profile data, and
calculating the target pressure for each tire using at least the tire profile data and the user profile data.

6. The method of claim 5, wherein the user profile data is selected from the group of: a performance selection, an economy selection and a durability selection.

7. The method of claim 1, further including:
by operation of the vehicle system
determining a vehicle position of a target tire from the plurality of tires, and
wirelessly transmitting the target pressure of the target tire.

8. The method of claim 7, wherein determining the vehicle position of the target tire includes detecting a change in pressure in the target tire.

9. A device, comprising:
wireless circuits configured to
communicate according to at least one wireless standard,
receive tire profile data for tires of a vehicle, and
transmit target pressure values for the tires;
memory circuits configured to store the tire profile data; and
processor circuits configured to calculate target pressure for each of the tires using at least the tire profile data.

10. The device of claim 9, wherein the at least one wireless standard is selected from the group of: a Bluetooth standard and an IEEE 802.11 wireless standard.

11. The device of claim 9, wherein the tire profile data is selected from the group of: tire manufacturer data, tire mileage data and tire warranty data.

12. The device of claim 9, wherein:
the memory circuits are further configured to store user profile data; and
the processor circuits are configured to calculate the target pressure for each of the tires using at least the tire profile data and user profile data; wherein
the user profile data is selected from the group of: a performance selection, an economy selection and a durability selection.

13. The device of claim 9, wherein the wireless circuits, memory circuits and processor circuits are formed in a same integrated circuit substrate.

14. A system, comprising:
a plurality of tire sensor circuits, each configured to sense at least a tire pressure for a tire of a vehicle and wirelessly transmit tire pressure data;
memory circuits configured to store tire profile data, the tire profile data being different than the tire pressure data;
a processor circuits configured to calculate a target pressure for each of the tires using at least the tire profile data; and
wireless circuits configured to wirelessly transmit the target pressure.

15. The system of claim 14, wherein the tire profile data is selected from the group of: tire manufacturer data, tire mileage data and tire warranty data.

16. The system of claim 14, wherein:
the memory circuits are further configured to store user profile data; and
the processor circuits are configured to calculate the target pressure for each of the tires using at least the tire profile data and user profile data; wherein
the user profile data is selected from the group of: a performance selection, an economy selection and a durability selection.

17. The system of claim 14, wherein the memory circuits and processor circuits are part of a vehicle system.

18. The system of claim 14, wherein the memory circuits and processor circuits are part of a user device separate from the vehicle.

19. The system of claim 14, wherein the processor circuits are further configured to determine which tire is being filled in a tire filling operation.

20. The system of claim 14, further including:
a tire filling device configured to at least inflate a tire of the vehicle, the tire filling device configured to
receive the target pressure for at least one tire, and
fill the at least one tire to the target pressure.
